(19) United States
(12) Patent Application Publication
(10) Pub. No.: US 2014/0172975 A1
(43) Pub. Date: Jun. 19, 2014

(54) Method and System to Create Social Capital

(71) Applicant: Patrick D. Smith, Deerfield, IL (US)

(72) Inventor: Patrick D. Smith, Deerfield, IL (US)

(21) Appl. No.: 13/718,370

(22) Filed: Dec. 18, 2012

(51) Int. Cl. H04L 29/08

(52) U.S. Cl. CPC H04L 67/22
USPC 709/204

(57) ABSTRACT

The present invention enables an objective deterministic calculation of social capital as it relates to a member of a social network being granted the ability to create a group of members, bind the grouped members to a software application's task comprised of a predetermined and measurable beginning, end, and goal, and measure the ability of the grouped members to complete the task.

### FIELD OF THE INVENTION

The present invention relates to a method and system to create social capital. The present invention further relates to the creation of social capital in networks where digital assets and communication services are provided. The present invention further relates to the creation of social capital in social network application domains.

### BACKGROUND OF THE INVENTION

Current Internet reputation systems provide a means for their members to gauge a relative level of quality and reputation of other members, and grouped members, and the member's and grouped member's digitized content and communications to provide a measure of trust in any specific socially networked Internet commerce and social networking application experience. Quality and reputation measurements provided by the systems are presented to their members through the member's viewing of an Internet reputation system's output on a social network member's digital display device.

More specifically, Internet reputation systems are widely used in commerce (e.g. Amazon.com, eBay etc) to bind by a database linkage, and make available for their members, qualitative and quantitative measures of quality and reputation to the sellers, and the products and services sellers provide their customers. Further, Internet reputation systems are also widely used in social networking application provider's domains (e.g. Facebook, MeetUp.com, LinkedIn etc) to bind by a database linkage the qualitative and quantitative measures of quality and reputation to their members, and grouped members, and the member's and grouped member's digitized content and communications.

The current methods Internet reputation systems use to create quality and reputation measurement for their members, and grouped members, and the member's and grouped member's digital content and communications fall into two categories: qualitative quality and reputation measurements and quantitative quality and reputation measurements.

Qualitative quality and reputation measurements refer to the ability, provided by the Internet reputation system provider, for their members to create quality and reputation claims consisting of freeform expressive digital media. The quality and reputation claims are binded by a database linkage to a member, and grouped members, and the member's and grouped member's digitized content and communications.

Amazon.com product reviews are an example of a textual quality and reputation claim posted by a member of the Amazon.com domain, (e.g. Amazon.com member, identified as member [humanReader123], writes and posts on the Amazon.com's webpage responsible for hosting a book product for sale, by a specific book publisher, a text review as follows: [humanReader123] “Of all of Shakespeare's plays, Hamlet is by far the best; the quality of this publisher's paper is also outstanding, much better than most I have encountered—highly recommended”). The textual quality and reputation claims are binded by a database linkage to the reviewed produce webpage and hosted in perpetuity on Amazon.com's Internet domain. The Amazon.com hosted quality and reputation claims can then be consumed by any of Amazon.com's members thus enabling any member the ability to judge for themselves whether the reviewed product or service will perform to the member's expectations.

As a further example, eBay seller reviews are another example of a freeform textual quality and reputation claim binded by a database linkage to individual eBay sellers, (e.g. eBay member identified as member [IBuyAnythingAtAPrice123] writes and posts on the seller's eBay webpage a text review as follows: [IBuyAnythingAtAPrice123] “This seller has great products but the worst delivery times I've ever seen—avoid!”). The database binding of the freeform textual quality and reputation claim by an eBay member to an eBay seller provides potential eBay member buyers with data they can use to gauge the quality and reputation of a seller and their products and services before the potential buying member commits to buying a product or service from any particular eBay seller. Both examples demonstrate how current how current quality and reputation measurements discourage sellers from providing products and services that are not able to fulfill the needs of the social network commerce members.

Further, both examples demonstrate how quality and reputation measurements can create positive feedback that can encourage sellers to expand their marketplace presence to the mutual benefit of buyers and sellers.

Further, qualitative quality and reputation claims can take the form of a combination of digital content types, (e.g. an audio review dubbed over a video of the product, or other relevant video information, is displayed on a digital display device, the review binded by a database linkage to a member, and grouped members, and the member's and grouped member's digitized content and communications).

The freeform nature of the qualitative quality and reputation claim allows any member of the Internet reputation system to create and publish a variety of different opinions, (e.g. great, good, ok, acceptable, criminal, and other quality and reputation expressing verbiage), in a variety of content delivery styles, (e.g. angry ranting, peaceful acceptance, customer delight, and other expressive emotive styles), over a variety of digital content and digital consumption types (e.g. audio, video and text). The inherent limitation of qualitative quality and reputation systems on its usefulness in a member assessing something's quality and reputation is this allowance of the system to allow a variety of opinions, content delivery styles, and digital content and consumption types, i.e. each and every quality and reputation claim is subjective and thus cannot be fully trusted in itself but must be interpreted by the Internet reputation system's members themselves as to whether a quality and reputation claim is valid and relevant. Internet reputation systems aggregation of many subjective quality and reputation claims linked to a single product, service, or member combats this limitation, but it does not remove from a member the responsibility for interpreting the resulting set of subjective quality and reputation claims.

Current Internet reputation systems also provide quantitative quality and reputation claim rating tools to their members. The quantitative quality and reputation rating tools provided take the form of a numeric value a member can bind by a database link to another member, and grouped members, and the member's and grouped member's digitized content and communications. The numeric value chosen by the member represents the member's perceived quality and reputation value as expressed on a bounded numeric scale, (e.g. worst to best on a scale of 1 to 10, three stars our of four, number of Facebook ‘Likes’, number of members who found a freeform quality and reputation review useful, and other visual forms, ratios, percentages, and combinations of same). The restriction of the quality and reputation value to a set range of numbers on a bounded numeric scale is a form of data normalization of the member's quality and reputation perceptions provided by an Internet reputation system member about another member, grouped members and the member's and grouped member's digitized content and communications. The data normalization compresses the freeform quality and reputation claims consisting of freeform expressive digital media types into a simple and easy to understand numeric value or numerical-based visual representation. This data normalization and representation approach of quality and reputation measurements are thus useful as an interpretative lens of relative quality and reputation across a set of other competing quality and reputation measured entities but does not remove the subjectivity of the underlying reviewing member's quality and reputation claim itself thus, while making the review digestion process faster for the viewing member, still requiring a member to accept the responsibility for interpreting the normalized data as valid and relevant for their needs.

Again, Internet reputation systems aggregation of multiple numeric-based subjective quality and reputation claims combats this limitation, but it does not remove from the quality and reputation seeking member the responsibility for interpreting the resulting set of numerically represented quality and reputation claims.

Further, the aggregation of multiple numerically normalized quality and reputation measurements creates the opportunity for abuse that is difficult for members to interpret without considering the underlying subjective quality and reputation data, potentially distorting the quality and reputation measurements themselves.

These abuses can come in the form of intended and unintended consequences of numerically measuring quality and reputation. An intended abuse can come in a form of, but is not limited to, aggressive competitors posting an overwhelming number of poor numerical quality and reputation measurements that alter the mathematical distribution of the aggregated measurement. Further, an intended abuse can come in a form of, but is not limited to, aggressive competitors posting poor numerical quality and reputation measurements at the time of a product launch to a marketplace and thus alter the perceptions of actual product quality without alerting Internet reputation systems of the possibility of malicious intent exhibited by an overwhelming number of bad reviews as the bad reviews are well positioned in time but not produced in suspiciously high quantities.

These aggressive competitive market forces can also be produced by, but is not limited to, actors who seek to manufacture the success of a product in a marketplace by overwhelming an Internet reputation system with many positive reviews or the placement of positive product reviews at well placed times, such as at the time of a product launch.

Unintended abuses can take the form of, but is not limited to, a member who has created a quality and reputation rating that is far removed from an average aggregate quality and reputation rating of an entity because the member's expectations are easily exceeded or not easily met; this is not to say that this set of members are malicious in intent but rather that the member perceptions on the quality and reputation of an entity fall outside what would be considered a normal socially perceived quality and reputation of another member, and grouped members, and the member's and grouped member's digitized content and communications.

A further current quality and reputation measurement technique is the use of a social network-based quality and reputation measurement assertion. A social network-based reputation measurement assertion is a measurement of quality and reputation based on a social network member re-asserting the truth of a quality and reputation claim posted online by another member in the social network. This re-assertion approach has become necessary to combat social identity misrepresentation. An example of social network identity misrepresentation is seen in LinkedIn's social network. LinkedIn allows any member to digitally display to other members textual claims that they possess a qualification, skill, or experience regardless of whether they actually possess the qualification, skill, or experience.

To combat the potential for quality and reputation misrepresentation of the member's claim, LinkedIn provides an online service in their social network to allow the member's assertions to be re-asserted by the member's social network connections. (e.g. John Y. asserts on his LinkedIn profile that he is a social media expert with 10 years of experience in the field of work. Mary X., a direct contact in John Y.'s LinkedIn social network, posts on John Y.'s LinkedIn profile webpage a re-assertion that John Y. is an expert in social media. The value of Mary X.'s assertion is subjectively judged by other LinkedIn members viewing John Y.'s LinkedIn profile webpage by their subjective opinion of Mary X.'s reason for the re-assertion).

Therefore, while a re-assertion of a quality and reputation claim does provide an alternative measurement of quality and reputation, the measurement is comprised of subjective claims and thus the measurement remains a subjective measurement requiring measurement viewers to interpret for themselves the validity of the resulting subjective measurement and claim. Further, any member's measured quality and reputation is subject to distortion as social network members can be socially or economically motivated to assert another member's quality and reputation in a professional skill as a means to gain social acceptance and social gain.

Another current technique to measure the quality and reputation of an Internet reputation system's member, and grouped members, and the member's and grouped member's digitized content and communications is to perform data mining on large sets of data that exist over a plurality of separately owned and operated Internet social network provider domains. Each social network provider's domain has unique data about their members, and grouped member's, and the member's and grouped member's digitized content and communications. Current approaches to create an increased scope for quality and reputation measurements by an Internet reputation system obtain data from each the member's social network provider's domains and applies a role up of all the quality and reputation measurements made available about the entity to extrapolate a rolled up quality and reputation measurement for any given member and grouped members. Further, these role up reputation systems also compute against the aggregation of the social network provider's raw data to come up with their own quality and reputation measurements; wherein raw data is comprised of member's, and grouped member's, and the member's and grouped member's digitized content and communications created in the separate social network domains.

An example of such a cross-domain role up is the social network data analyzer, Klout. Klout performs quality and reputation analysis on individuals and publishes the analysis results as a single Klout number; the higher the Klout number indicating the strength of an individual's quality and reputation. Again, the subjective nature of the aggregated quality and reputation measurements and the raw data prevents this approach to be an objective measure of social capital as it is based on a quality and reputation measurement in a social network consisting of a collection of inherently subjective claims.

In summary there are inherent limitations in current approaches to create social capital through the binding of a subjective quality and reputation measurement to an Internet reputation system's member, and grouped members, and the member's and grouped member's digitized content and communications. Further, the current quality and reputation measurement systems focus on subjective quality and reputation measurements of the digital content and communications of the members and grouped members not the quality and reputation of the members and grouped members themselves.

### SUMMARY OF THE INVENTION

The present invention creates an objective quantification of social capital in a social network through systematic collection and calculation of deterministic data provided by a social network's members, and grouped members, and the measurement of the grouped members efforts to complete a software application's task.

In one embodiment, the invention can be characterized as a method of social capital creation in a social network comprising the steps of: a collection of a plurality of social network identity data for each member; a formation of the members into groups; a sorting of the grouped members into an ordered list; a calculation of social network identity difference data between contiguous members of the ordered list; a binding of a software application's task to the grouped members; a calculation of a best possible outcome, of members, and grouped members, to complete the software application's task; a calculation of a probability of members, and grouped members, likelihood of completing the software application's task; a calculation of members, and grouped members, actual performance in completing the software application's task; and a calculation of a resulting social capital produced by this process for the social network members, and grouped members.

In another embodiment, the invention can be characterized as a system of social capital creation in a social network comprising: social network members; social network identity data for each member; a member's computing and display device providing a means to enter and save the member's social network identity data and interact with the social capital creation system and software application tasks through a coupling of an application programming interface; a plurality of social task producing software applications; a social organizer software application logic producing member's, and grouped member's, social organization data; a social task organizer software application logic producing member's, and grouped member's, task organizing data; a social capital calculator software application logic producing a member's, and grouped member's, relative social network identity data differences data, a best possible score achievable to complete a software application's task data, probable likelihood to complete the software application's task data, actual performance of completing the software application's task data, and social capital data.

### BRIEF DESCRIPTION OF THE DRAWINGS

FIG. 1 illustrates an embodiment in accordance with the invention of the logical structure of a social capital creating system.

FIG. 2 illustrates an embodiment in accordance with the invention of a possible set of contents of the social network identity data for each member.

FIG. 3 illustrates an embodiment in accordance with the invention of a possible set of contents of the social network identity data for a grouped member.

FIG. 4 illustrates an embodiment in accordance with the invention of a possible set of contents of member social network identity data differences calculated for a social network's unique grouped members; wherein the example of social network identity data differences calculated are between two social network members.

FIG. 5 illustrates an embodiment in accordance with the invention of an organization of a single member unique grouped member.

FIG. 6 illustrates an embodiment in accordance with the invention of an organization of a serially organized unique grouped member set of members.

FIG. 7 illustrates an embodiment in accordance with the invention of an organization of a ring organized unique grouped member set of members.

FIG. 8 illustrates an embodiment in accordance with the invention of an organization of a star organized unique grouped member set of members.

FIG. 9 illustrates an embodiment in accordance with the invention of an organization of a tree organized unique grouped member set of members.

FIG. 10 illustrates an embodiment in accordance with the invention of an organization of a mesh organized unique grouped member set of members.

FIG. 11 illustrates an embodiment in accordance with the invention of an organization of a multi-network proxy organized unique grouped member set of networks and members.

FIG. 12 illustrates an embodiment in accordance with the invention of an example calculation of social network identity data differences between two members organized into a unique grouped member set of members.

### DETAILED DESCRIPTION OF THE PREFERRED EMBODIMENT

The present invention addresses the need of members, and groups of members, in a social network to create objective measures of social capital for themselves and their social groups. The system takes the control of the measurements of who members are and how they behave from the inherent errors and misrepresentation produced by subjective interpretations of humans and computing platforms and gives it back to the social member; a form of social responsibility calculated and expressed as an objective measure of social capital based on the member's, and grouped member's, quantified social network identity data and their measurable actions.

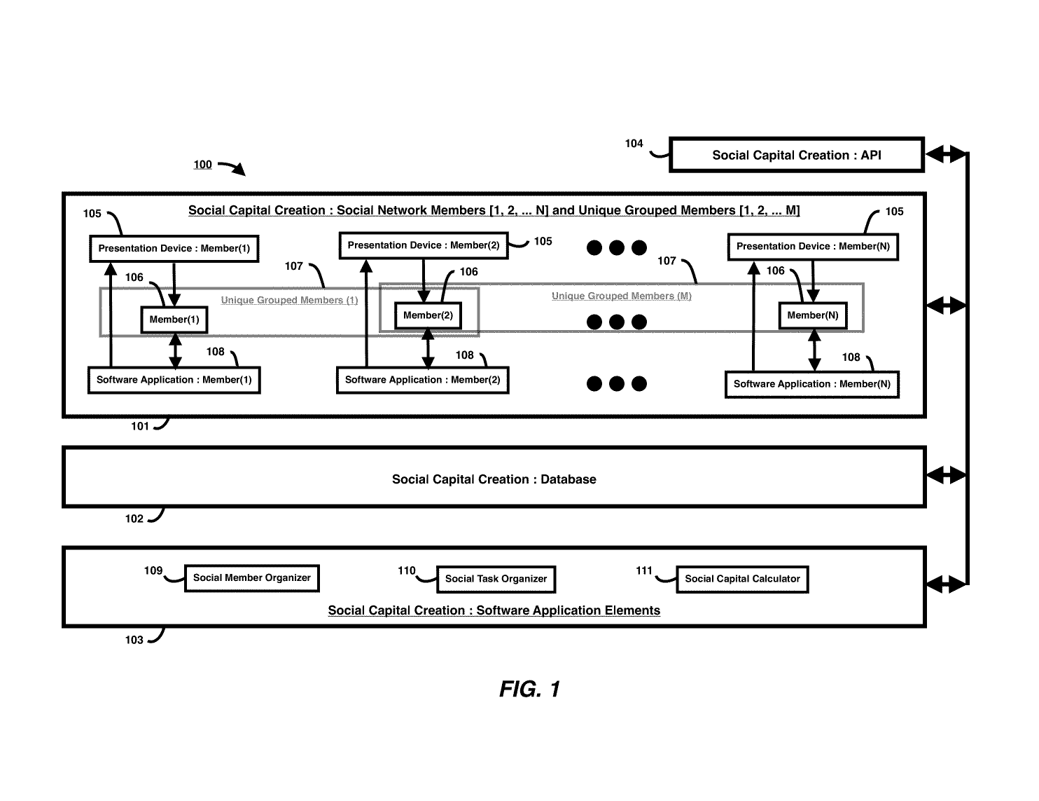

An embodiment of the invention's capital creating system is shown in FIG. 1, wherein the social capital creation system (100) is comprised of a social network (101) containing members (106) and unique grouped members (107) possessing and operating a software application (108) that is logically coupled to the social capital creating system application programming interface (104), social capital creation system database (102), and social capital creation software application elements (103) composed of a social member organizer (109), a social task organizer (110), and a social capital calculator (111). The software application (108) presents to the social network member (106), and unique grouped members (107), through a graphical user interface on the member's computing and presentation device (105), the social capital creating system's (100) graphical representation of member (106) interactions with the social capital creating system (100) and the software application's (108) tasks. Further specifically, the social capital creation system's (100) embodiment of the software application (108) resides on, but is not limited to, the member's mobile computing and display device (105), such as a mobile phone and mobile tablet. Further specifically, the social capital creation system's (100) embodiment of the application programming interface (104) resides on, but is not limited to, the member's mobile computing and display device (105), such as a mobile phone and mobile tablet. Further specifically, the social capital creation system's (100) embodiment of the social capital creation software application elements (103) resides on, but is not limited to, the member's mobile computing and display device (105), such as a mobile phone and mobile tablet. Further specifically, the social capital creation system's (100) embodiment of the social capital creation system database (102) resides on, but is not limited to, the member's mobile computing and display device (105), such as a mobile phone and mobile tablet and in a centralized computing server reachable for data reading and writing through commonly known Internet technologies.

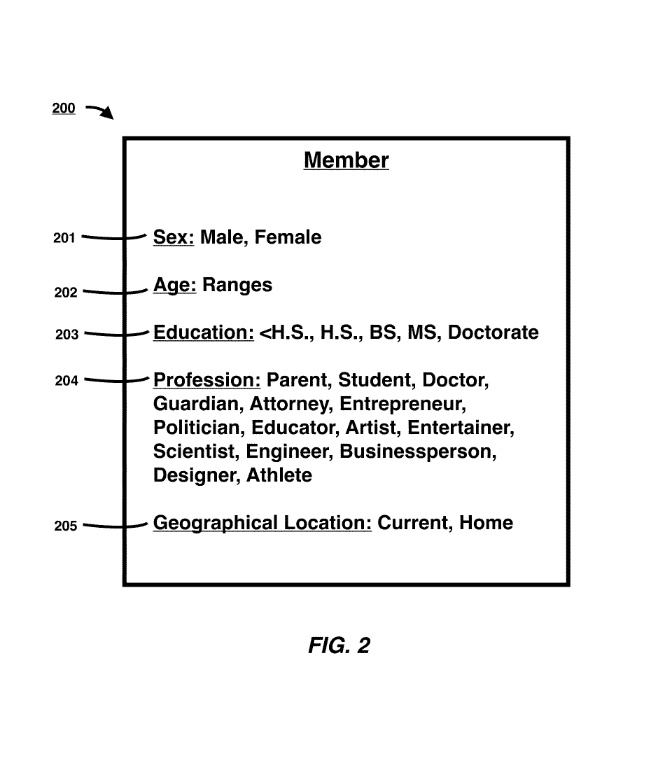

For the social network member (106) to interact with the social capital creating system (100) and its software applications (108) members (106) provide to the system their social network identity data in a form that prevents ambiguity in any one data's interpretation by a computing device, thus providing the means for the social capital creating system (100) to measure with a numerical representation a set of data common to all social network members. FIG. 2 is an embodiment of the data set and is represented in the social capital creating system (100) to the social network member (106) as a set of member social network identity data classes (200) designed to be understood by humans and represented numerically to computing devices. Formats of the member's social network identity data may take many forms to fulfill above human understanding and computing requirements. The embodiment of the invention's data forms of the member social network identity data classes (200) take the form of booleans (201), such as sex [male, female]; categorical ranges organized as a class of numerical ranges (202), wherein each numerical range has associated with it a predetermined numerical value useful to the social capital creating system (100), such as the grouping of ages [5-17 years old, 18-25 years old, etc]; categorical ranges organized as a class of attributes with a single possible choice (203), wherein each numerical range has associated with it a predetermined numerical value useful to the social capital creating system (100), such as levels of education [<High School, High School, Bachelors Degree, Masters Degree, Doctorate, etc]; categorical ranges organized as a class of attributes with multiple simultaneous input choices, each choice coupled with a numerical percentage input (204), wherein the numerical percentage ranges entered by the member indicate the numeric proportion of their identification in any one attribute class, such as a profession [Parent, Student, Doctor, Guardian, Attorney, Entrepreneur, Politician, Educator, Artist, Entertainer, Scientist, Engineer, Businessperson, Designer, Athlete, etc]; and pure numerical forms (205), such as a geographical location data in a longitude and latitude format.

With the member social network identity data (200) it is now possible for any member (106) in the social capital network system (100) to organize members (106) into a unique grouped member (107) set of members (106). Unique grouped members (107) are organized by the member (106) coupled to the social capital creating system's (100) social member organizer (109) through an application programming interface (104); wherein the social member organizer (109) provides the functions of gathering the members (106) into an ordered list indicative of each members (106) logical position relative to each other and to present on the member's presentation device (105) a means for the sorted list to be rearranged into any member-to-member order, and thus define members (106) desired network connections (501).

Further specifically, an embodiment of the member (106) creating the unique grouped member (107) set of members (106) allows the member (106) to select, on their mobile presentation device (105), social network members (106) from the member's mobile presentation device (105) contact list and their various social network contacts lists, (e.g. LinkedIn, Facebook, MeetUp.com, Google+ etc), and to order this member (106) list to reflect any specific member's (106) logical position, the logical position manifesting itself as a network connection (501), relative to other members (106) on the ordered list and reflective of the organizing member's (106) desired composition of the unique grouped member (107) set of members (106).

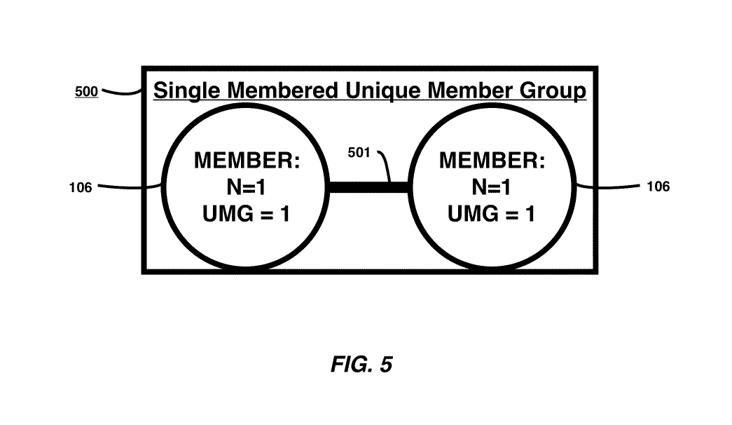

Further specifically, the ordered list, reflecting the member's (106) desired member-to-member network connections (501), can take a plurality of forms as illustrated, but not limited to, across FIG. 5 through FIG. 11, each of which are discussed in turn.

FIG. 5 illustrates an embodiment of the network connection (501) of a member (106) to themselves (500). This reflects the member's (106) intent to perform a software application's (108) task and to be measured on their effectiveness to achieve a goal defined by the software application's (108) task.

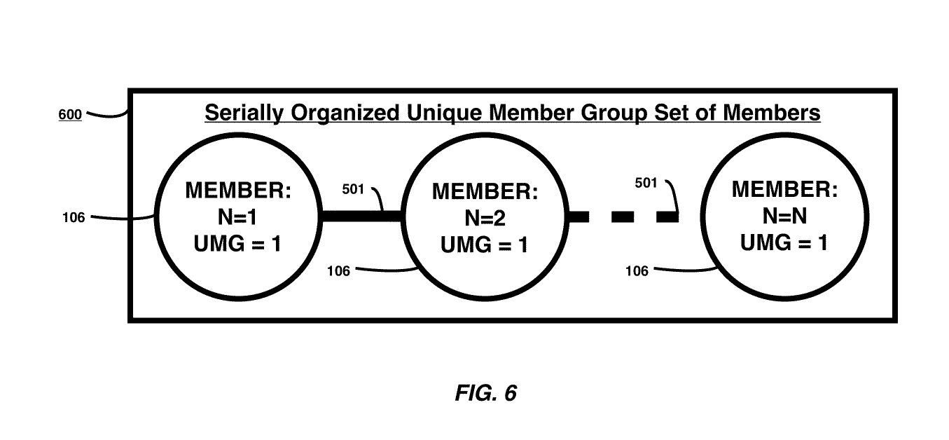

FIG. 6 illustrates an embodiment of the set of network connections (501) of a serially organized unique grouped member (600) set of members (106); wherein the serial organization reflects a unique grouped member's (107) intent to complete a software application's (108) task in a member-to-member consecutive order. The serial ordering thus creates a social network capital creating interdependency experience dependent on each other's performance in that any one member (106) is dependent on the previous member's (106), as positioned on the ordered list relative to the dependent member (106), willingness and ability to complete the software application's (108) task before the order dependent member (106) may demonstrate their willingness and ability to complete the software application's (108) task. Therefore the member's (106), and unique grouped member's (107), social capital score is based on the following two measurements; first, on the member's (106) individual contribution to achieve the goal defined by the software application's (108) task and, second, on the unique grouped member's (107) combined member's (106) contributions to achieve the goal defined by the software application's (108) task. Further specifically, the serially organized unique grouped member (600) set of members (106), as illustrated, defines an order of [Member[1,1], Member [2,1], . . . Member[N,1]], wherein ‘N’ is the number of serially organized unique grouped members (600) and ‘1’ identifies the unique grouped member (107) set of members (106) requested to completed the software application's (108) task.

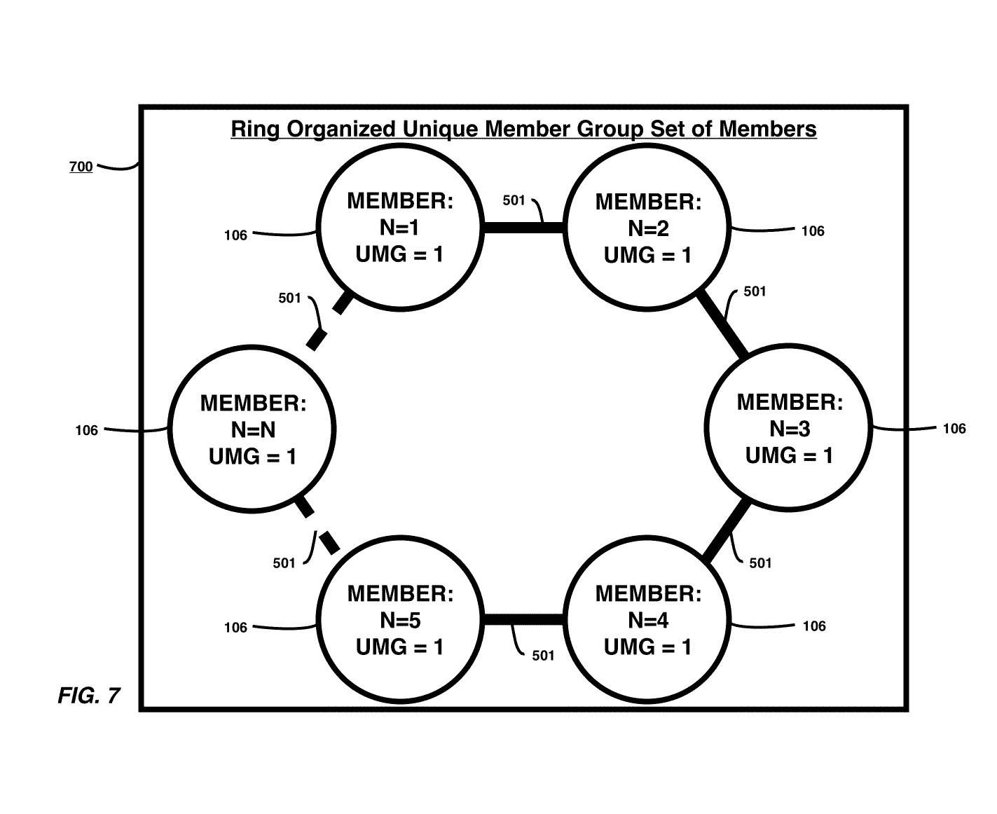

FIG. 7 illustrates an embodiment of the set of network connections (501) of a ring organized unique grouped member (700) set of members (106); wherein the ring organization reflects a unique grouped member's (107) intent to complete a software application's (108) task in a member-to-member consecutive order. The ring ordering thus creates a social network capital creating interdependency experience dependent on each other's performance in that any one member (106) is dependent on the previous member's (106), as positioned on the ordered list relative to the dependent member (106), willingness and ability to complete the software application's (108) task before the order dependent member (106) may demonstrate their willingness and ability to complete the software application's (108) task. Therefore the member's (106), and unique grouped member's (107), social capital score is based on the following two measurements; first, on the member's (106) individual contribution to achieve the goal defined by the software application's (108) task and, second, on the unique grouped member's (107) combined member's (106) contributions to achieve the goal defined by the software application's (108) task. Further specifically, the ring organized unique grouped member (700) set of members (106), as illustrated, defines an order of [Member[1,1], Member [2,1], Member [3,1], Member [4,1], Member [5,1], . . . Member[N,1], Member[1,1]], wherein ‘N’ is the number of ring organized unique grouped members (700) and ‘1’ identifies the unique grouped member (107) set of members (106) requested to completed the software application's (108) task. The ring organized unique grouped member (700) set of members (106) differs from other network organizations in that the unique group organizing member (106), Member[1,1] in this example, plays a role as the first member (106) in the ordered list requested to complete the software application's (108) task and as the last member (106) in the ordered list to complete the software application's (108) task.

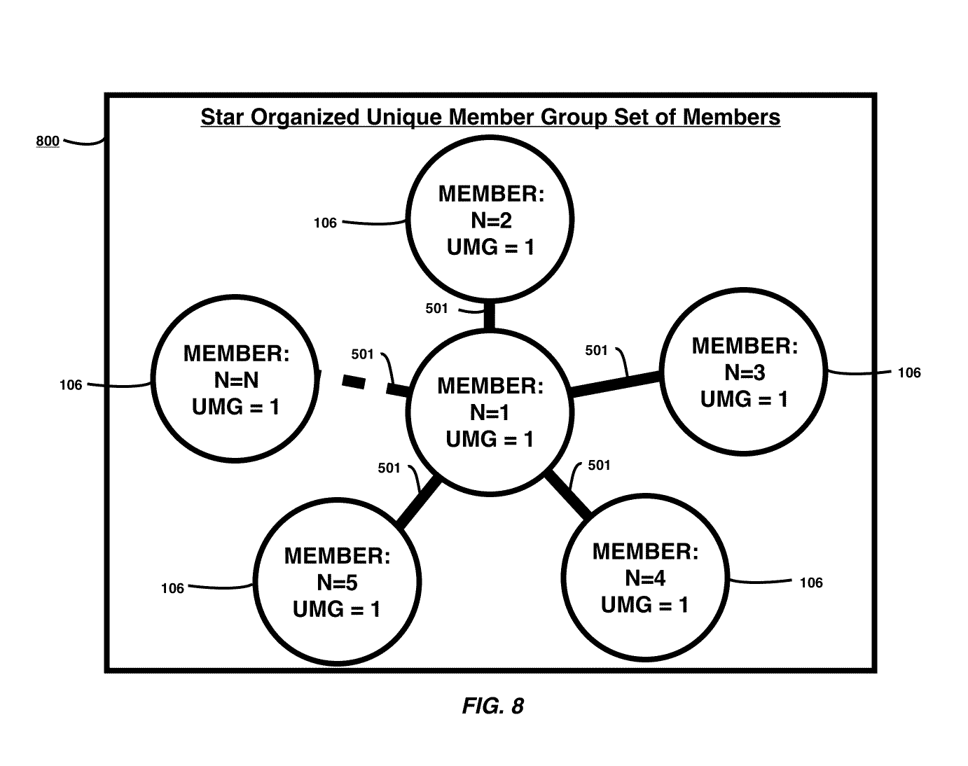

FIG. 8 illustrates an embodiment of the set of network connections (501) of a star organized unique grouped member (800) set of members (106); wherein the star organization reflects a unique grouped member's (107) intent to complete a software application's (108) task in a member-to-member consecutive order where one member (106) acts as a hub network connection between any other member (106) of the unique grouped member (107) set of members (106). The star ordering thus creates a social network capital creating interdependency experience dependent on each other's performance in that any one member (106) is dependent on the previous members (106), as positioned on the ordered list relative to the dependent member (106), willingness and ability to complete the software application's (108) task before the order dependent member (106) may demonstrate their willingness and ability to complete the software application's (108) task. Therefore the member's (106), and unique grouped member's (107), social capital score is based on the following two measurements; first, on the member's (106) individual contribution to achieve the goal defined by the software application's (108) task and, second, on the unique grouped member's (107) combined member's (106) contributions to achieve the goal defined by the software application's (108) task. Further specifically, the star organized unique grouped member (800) set of members (106), as illustrated, defines an order of [Member[1,1], Member [2,1], Member[1,1], Member [3,1], Member[1,1], Member [4,1], Member[1,1], Member [5,1], . . . Member[N,1], Member[1,1]], wherein ‘N’ is the number of star organized unique grouped members (800) and ‘1’ identifies the unique grouped member (107) set of members (106) requested to completed the software application's (108) task. The star example differs from other network organizations in that the unique group organizing member (106), Member[1,1] in this example, plays a role as the first member (106) in the ordered list requested to complete the software application's (108) task as well a repeated member (106) in the ordered list requested to complete the software application's (108) task and also as the last member (106) in the ordered list to complete the software application's (108) task.

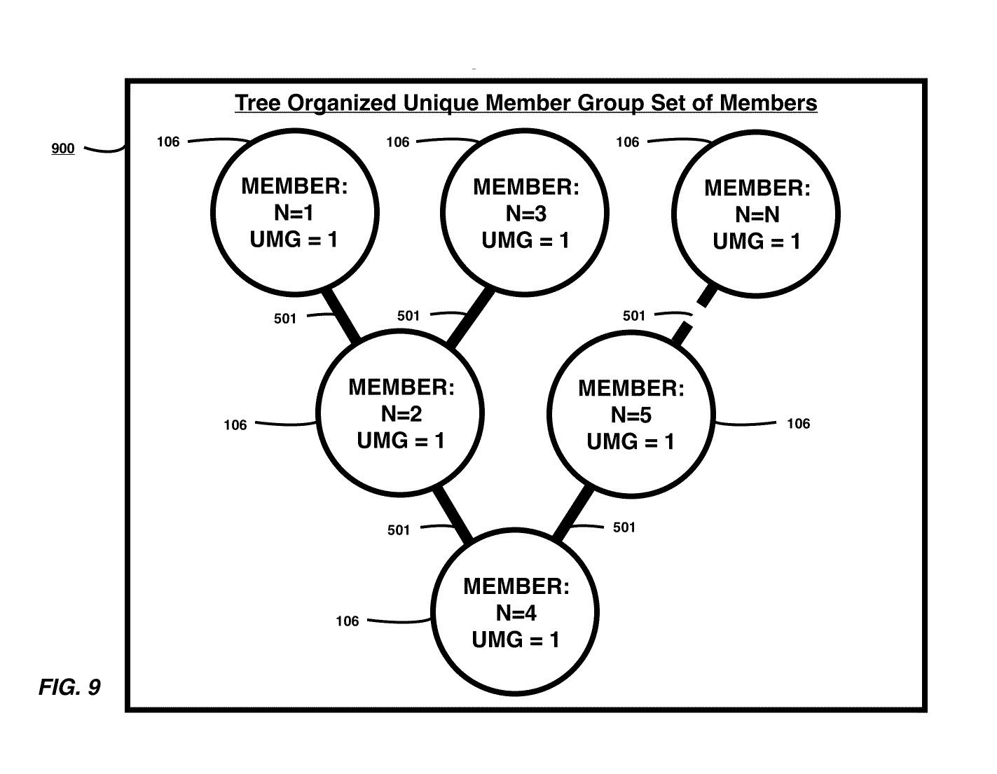

FIG. 9 illustrates an embodiment of the set of network connections (501) of a tree organized unique grouped member (900) set of members (106); wherein the tree organization reflects a unique grouped member's (107) intent to complete a software application's (108) task in a member-to-member consecutive order for any leg of the tree while allowing multiple legs of the tree to act on their task requests as they are received, thus providing a social network experience that allows for a parallel processing of the software application's (108) tasks. The tree ordering thus creates a social network capital creating interdependency experience dependent on each other's performance in that any one member (106) is dependent on the previous member's (106), as positioned on the ordered list relative to the dependent member (106), willingness and ability to complete the software application's (108) task before the order dependent member (106) may demonstrate their willingness and ability to complete the software application's (108) task. Therefore the member's (106), and unique grouped member's (107), social capital score is based on the following two measurements; first, on the member's (106) individual contribution to achieve the goal defined by the software application's (108) task and, second, on the unique grouped member's (107) combined member's (106) contributions to achieve the goal defined by the software application's (108) task. Further specifically, the tree organized unique grouped member (900) set of members (106), as illustrated, demonstrates a plurality of ordered lists ‘L’ as follows: L1=[Member[1,1], Member [2,1], Member[4,1], Member[5,1], . . . Member[N,1]]; and L2=[Member[1,1,], Member[2,1], Member[3,1]], wherein ‘N’ is the number of tree organized unique grouped members (900) and ‘1’ identifies the unique grouped member (107) set of members (106) requested to completed the software application's (108) task. The tree example differs from other network organizations in that the unique group organizing member (106), Member[1,1] in this example, is permitted, by the social capital creating system (100), to produce multiple independent network connections for the unique grouped member (107) set of members (106), wherein each member (106) is serially dependent on the single previous member's (106) ability and willingness to complete the software application's (108) task before the dependent member (106) may demonstrate their ability and willingness to complete the software application's (108) task while also permitting any given member (106) in the unique grouped member (107) set of members (106) to be listed on more than one ordered list ‘L’ allowing for the possibility of tree networks that support parallel software application (108) task completion.

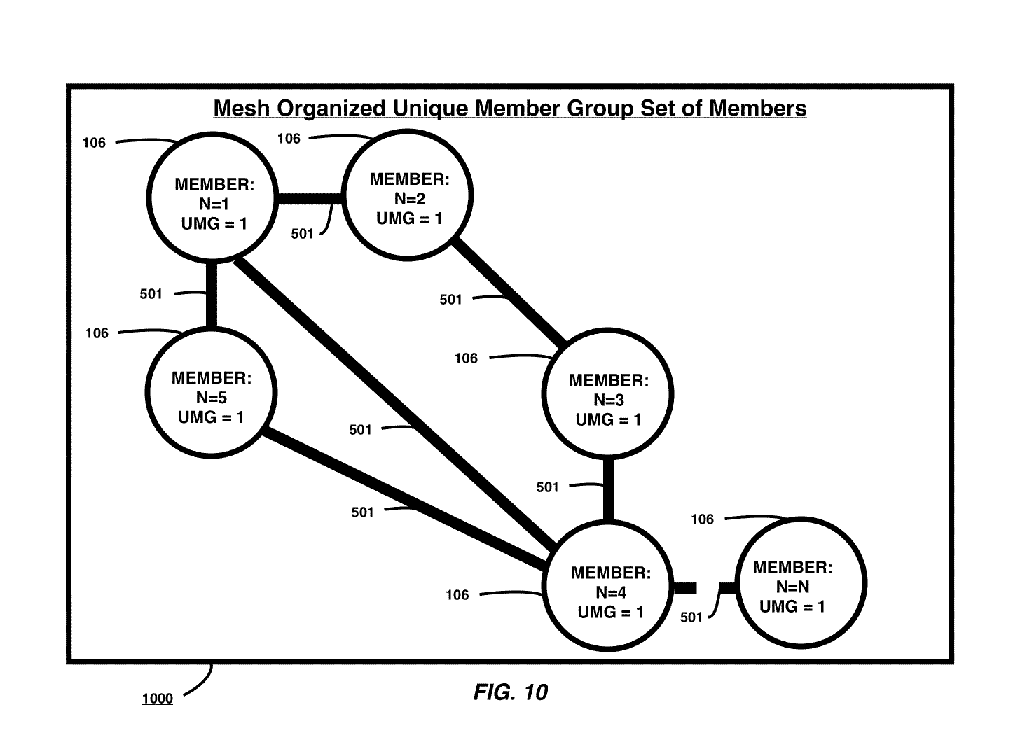

FIG. 10 illustrates an embodiment of the set of network connections (501) of a mesh organized unique grouped member (1000) set of members (106); wherein the mesh organization reflects a unique grouped member's (107) intent to complete a software application's (108) task in a member-to-member consecutive order for any leg of the mesh while allowing multiple legs of the mesh to act on their task requests as they are received, thus providing a social network experience that allows for parallel processing of the software application's (108) task. The mesh ordering thus creates a social network capital creating interdependency experience dependent on each other's performance in that any one member (106) is dependent on the previous member's (106), as positioned on the ordered list relative to the dependent member (106), willingness and ability to complete the software application's (108) task before the order dependent member (106) may demonstrate their willingness and ability to complete the software application's (108) task. Therefore the member's (106), and unique grouped member's (107), social capital score is based on the following two measurements; first, on the member's (106) individual contribution to achieve the goal defined by the software application's (108) task and, second, on the unique grouped member's (107) combined member's (106) contributions to achieve the goal defined by the software application's (108) task. Further specifically, the mesh organized unique grouped member (1000) set of members (106), as illustrated, demonstrates a plurality of ordered lists ‘L’ as follows: L1=[Member[1,1], Member [2,1], Member[3,1], Member[4,1], . . . Member[N,1]]; L2=[Member[1,1,], Member[4,1], . . . Member[N,1]]; and L3=[Member [1,1], Member[5,1], Member[4,1], . . . Member[N,1]], wherein ‘N’ is the number of mesh organized unique grouped members (1000) and ‘1’ identifies the unique grouped member (107) set of members (106) requested to completed the software application's (108) task. The mesh example differs from other network organizations in that the unique group organizing member (106), Member[1,1] in this example, is permitted, by the social capital creating system (100), to produce multiple independent network connections for the unique grouped member (107) set of members (106), wherein each member (106) is serially dependent on at least one, and possibly multiple, previous member's (106) ability and willingness to complete the software application's (108) task before the dependent member (106) may demonstrate their ability and willingness to complete the software application's (108) task. Further, the mesh organization allows for any given member (106) in the unique grouped member (107) set of members (106) to be listed on more than one ordered list ‘L’. Further, the mesh organization allows for any given member (106) in the unique grouped member (107) set of members (106) to be dependent on more than one member's (106) willingness and ability to complete the software application's (108) task before the dependent member is granted permission to demonstrate the willingness and ability to complete the software application's (108) task.

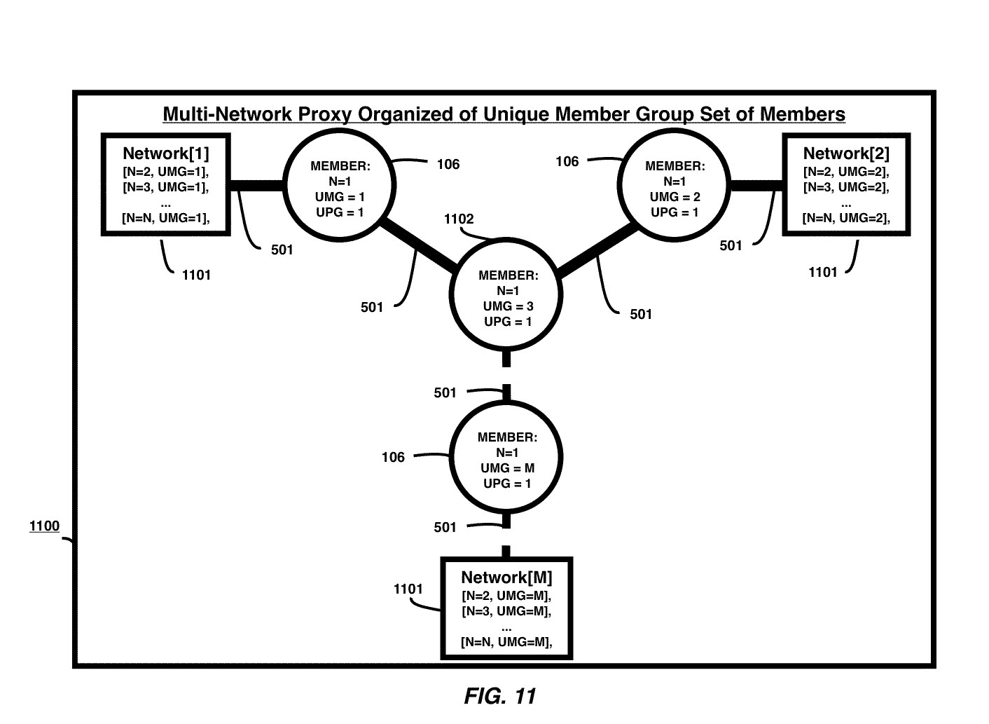

FIG. 11 illustrates an embodiment of the set of network connections (501) of a multi-network proxy organized unique grouped member (1100) set of members (106); wherein the multi-network proxy organization reflects a grouping of multiple networks (1101) of unique grouped member (107) set of members (106) intent to complete a software application's (108) task in a member-to-member consecutive order in a specific network organization (1101) while allowing the networks (1101) to be logically connected together into a larger network of networks through a proxy member (1102) that connects ‘M’ unique networks (1101), thus providing a social network experience that allows for parallel processing at the network-to-network level of organization independent of the underlying organization of any of the individually organized networks (1101). The proxy network-to-network ordering thus creates a social network capital creating interdependency experience dependent on each network's (1101) performance and ability and willingness to complete the software application's (108) task. Therefore the proxy's (1102), and unique grouped network's (1101) social capital score is based on the following two measurements; first, on the network's (1101) contribution to achieve the proxy goal defined by the software application's (108) task and, second, on the unique proxy grouped member's (1102) combined network's (1101) contributions to achieve the goal defined by the software application's (108) task. Further specifically, the multi-network proxy organized unique grouped member (1100) set of members (106), as illustrated, demonstrates a plurality of individually ordered networks (1101), wherein ‘M’ is the number of networks (1101). The multi-network proxy example differs from other network organizations in that any network (1101) is permitted, by the social capital creating system, to produce multiple independent network connections for the proxy (1102), wherein each network (1101) relative to the proxy (1102) may be organized to complete their task in any of the previously discussed network organization methods (e.g. individual member, serially, star, tree, and mesh).

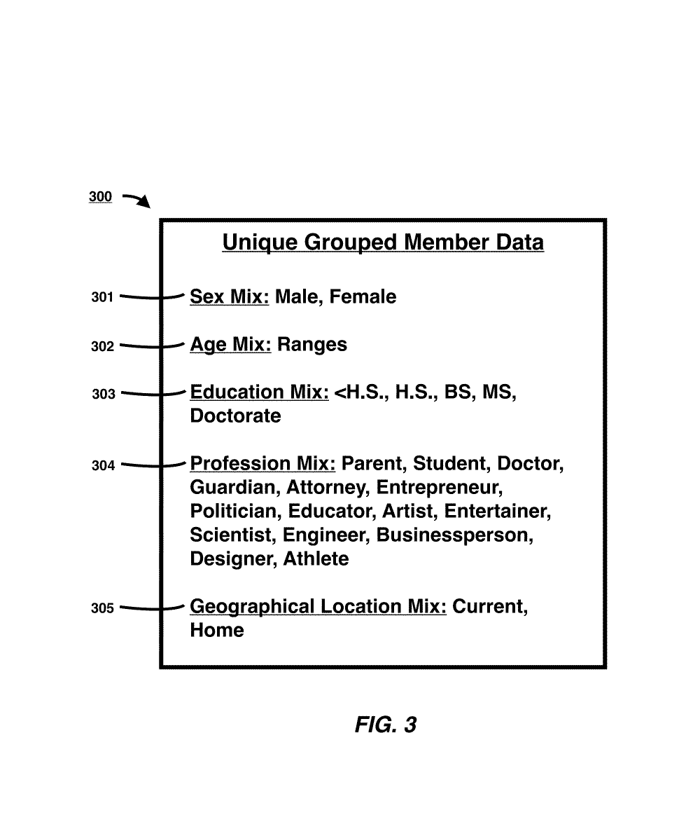

With members (106) organized into unique grouped member (107) set of members (106), and thus member-to-member network connectivity (501) defined, it is now possible for the social capital creation system (100) to calculate with its social capital calculator (111) the numerical social identity network data differences based on each member's (106) relative position to each other. As discussed in the previous discussion of the social network identity data topic, social network identity data differences are able to be calculated because of the social capital creation system's (100) requirement that each member (106) provide their social network identity data over the same classes of attributes and in the same format as every other social capital creation system member (106). The social capital creation system (100) then examines each class of elements in the member's (106) social network identity data to the like class of elements between contiguous members (106), as defined by the organization of the members (106), and expressed as the ordered list examples in the previous examples of organization. The composite social network identity data is shown in FIG. 3 and expressed as the unique grouped member data (300); wherein, with the exception of the data being comprised of several member's (106), organized in the unique grouped member (107) set of members (106), is composed of the same classes and data types as FIG. 2; the set of unique grouped member data (300), in this example, comprising a sex mix (301), age mix (302), education mix (303), profession mix (304), and geographical location mix (305).

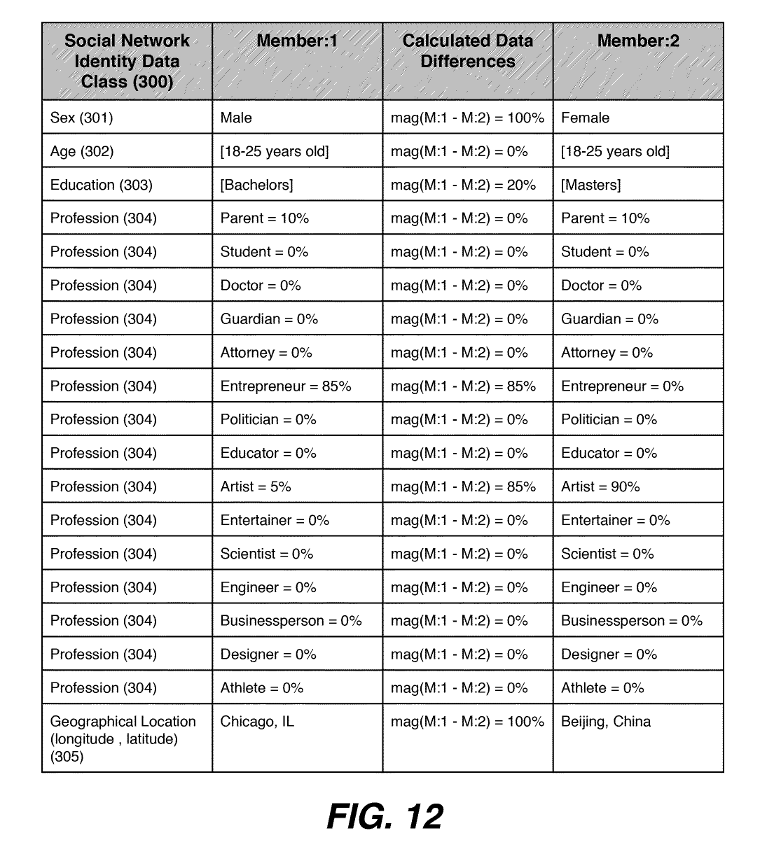

An example of two members (106) organized into an unique grouped member (107) set of members (106), and have provided their individual social network identity data, is shown in FIG. 12 along with the social network identity data differences calculated by the social capital calculator (111). As FIG. 12 demonstrates, the resulting data differences are a magnitude difference, indicated by the term ‘mag’, taken between the two member's (106) data. The social network identity data differences are then saved to the social capital creation system database (102) for further calculations by the social capital creation system (100).

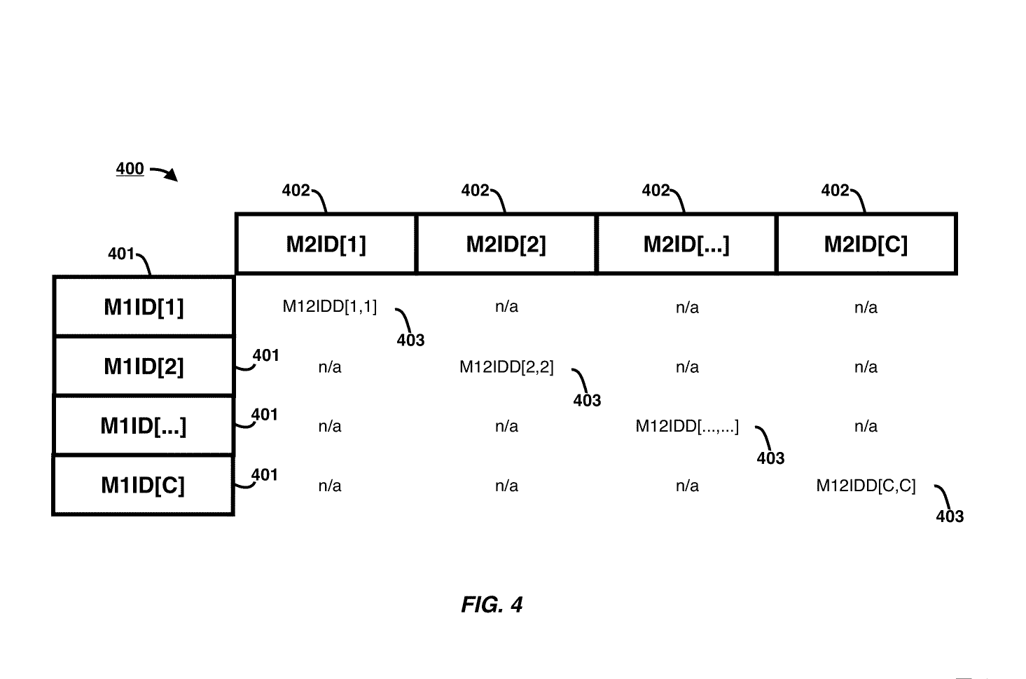

An embodiment of the memory locations of the social network identity data differences is shown in FIG. 4; wherein a single social network identity data difference calculation set between two members (400) is indexed, in this example, as Member ‘1’ social network identity data classes ‘1’ through ‘C’ represented by M1ID[C] (401), and Member ‘2’ social network identity data classes ‘1’ through ‘C’ represented by M2ID[C] (402) and results in, through use of the social capital calculator (111) as a set of calculated member-to-member social network identity data differences M12IDD[C,C] (403) computed across all member's (106) social network identity data classes (200). Further specifically, the unique grouped member (107) set of members (106) will contain multiple social network identity data difference sets proportional to the number of member-to-member turns it takes to complete the software application's (108) task.

With members (106) organized into unique grouped members (107) composed of member-to-member ordering of when the software application's (108) task is permitted by any one member (106) to be executed we can now turn to the topic of what comprises the software application's (108) task that has been binded by a database linkage to the unique grouped member (107) set of members (106) by the social capital creation system's (100) social task organizer (110) after which we will be able to exercise, and demonstrate through example, all the elements of the social capital creation system (100) in order to calculate the social capital for each member (106) and the unique grouped member (107) set of members (106).

A software application (108) task is defined as any software application based task that has a measurable beginning and end state. Software applications (108) useful to the social capital creation system (100) include, but are not limited to, gaming applications, utility applications, social communication applications, and content creation applications. A brief example for each class of software applications (108) useful to the social capital creation system (100) are as follows.

An example of a task provided by the software application (108) is produced by a gaming class of software applications (108) that members (106) play as a form of entertainment. An example of a game application is a simulated maze game comprising a simulated ball whose position in the maze is responsive to the orientation of the member's presentation device (105), such orientations manifested by an accelerometer on the presentation device (105) that measures spatial position, wherein the maze limits the ball's movements with simulated maze walls the ball cannot penetrate. The goal of this task is for the member (106) to move the ball through the maze by various orientations of the member's presentation device (105) from a beginning location to an ending location; wherein when the ball has reached the ending location the task is complete for that member (106) and the software application's (108) task, of completing the maze in this example, is passed to the next member (106) in the unique grouped member (107) set of members (106).

A further example of a task provided by the software application (108) is produced by a utility software application (108) that members (106) use as a means to perform useful work. An example of a utility application is a marketing survey expressed as a data entry form comprised of questions, wherein each member (106) completes the data entry form and when the form is completed by the member (106) the task is ended for that member (106) and the task may be passed to the next member (106) of the unique grouped member (107) set of members (106). The goal of this example task is to motivate and coordinate the unique grouped member (107) set of members (106) to complete, in a timely manner, a marketing survey useful for a marketing study.

A further example of a task provided by the software application (108) is produced by a social communication software application (108) used to communicate among a unique grouped member (107) set of members (106). An example of a social communication application is a voting application whose results, after they are completed by any given member (106), are communicated to the next member (106) of the unique grouped member (107) set of members (106); wherein, as an example, the vote is comprised of a list of restaurants the member (106) proposes the unique grouped member (107) set of members (106) should go for lunch that day. The goal of this example task is to motivate and coordinate the unique grouped member (107) set of members (106) to efficiently communicate, in a timely manner, in order to make a decision.

A further example of a task provided by the software application (108) is produced by a content creation software application (108) used to create digital content. An example of the content creation application is when the member (106) invites the unique grouped member (107) set of members (106) to add a graphical visualization input, such as lines and colors, to a digitized picture each member (106) interacts with to create a new visual design element before forwarding the altered digital picture to the next member (106) in the unique grouped member (107) set of members (106). The goal of this example task is to stimulate and coordinate across the unique grouped member (107) set of members (106), in a timely manner, a creative process.

As demonstrated by these task examples, each task is composed of steps that each member (106) completes before the next member (106) of the organized unique grouped member (107) set of members (106) can provide their input to complete the task. When all the unique grouped member (107) set of members (106) have completed their task responsibilities the task-to-task and member-to-member interdependence created by the social capital creation system (100) is completed and the member's (106) and the unique grouped member (107) set of members (106) can then be evaluated for their effectiveness in completing the software application's (108) task. The effectiveness manifests itself as calculated numerical social capital scores for individual members (106) and unique grouped member (107) set of members (106).

In order to normalize the performance of members (106) and unique grouped member (107) set of members (106) a further processing of the likelihood, based on the composition and ordered list organization of the relative social network identity data differences, of the task being completed by unique grouped member (107) set of members (106) is calculated by the social capital creation system's (100) social capital calculator (111); this process of normalization allows viewers of the social capital creation system's (100) outputs associated to any member (106), and unique grouped member (107) set of members (106), to be comparable on a similar scale of achievement. This normalization is provided by the calculation, by the social capital calculator (111), of the best case scenario for the task being completed and a likelihood for the task being completed by the unique grouped member (107) set of members (106). This calculation is done in two stages: first, as the member-to-member best case scenario and likelihood calculation and, second as a composite unique grouped member (107) set of members (106) best case scenario and likelihood calculation. As demonstrated by the social network identity data differences discussion, it is apparent that the social capital creation system (100) is capable of connecting members (106) with vastly different social network identities and geographical locations, and thus provides a rich possibility of social interactions based on the willingness and ability of the unique grouped member (107) set of members (106) to perform and complete the software application's (108) task in a timely manner.

For the sake of simplicity, but without loss of generality, we focus our example on a single parameter of the social network identity data differences to demonstrate how such a normalization for the member (106) and their unique grouped member (107) set of members (106), in its embodiment, would be calculated and used in the social capital creation system (100).

Consider four members, M:1, M:2, M:3, and M:4, who have serially organized (600) themselves into two unique grouped member (107) sets of members (106); UGM:1, composed of M:1 and M:2 and UGM:2, composed of M:3 and M:4. UGM:1 and UGM:2 have chosen the same software application (108) task to complete, say the successful completion, by each UGM's (107) set of members (106), of the maze game software application (108) as described earlier with the additional task goals of completing the maze, once started by any one member (106), in under 1 minute and to have the task completed by all members (106) of the UGM (107) set of members (106) in less than fifteen minutes. When the social network identity data differences are calculated for each UGM (107) set of members (106) the following are the only social network identity data differences demonstrated across the groups: UGM1 has a geographical location social network identity data difference of 10 kilometers, likely locating them in the same time zone, and UGM2 has a geographical location social network identity data difference of 17,642 kilometers (Chicago, II to Bejing, China) and thus placing them in almost entirely opposite timezones, wherein when it is night in one place it is day in the other and visa versa. The measured social capital, indicative of the intended social coordination between members (106), possible between these two diverse UGM (107) set of members (106) is thus quite different as the likelihood of completing the task's composite goals are much more likely in UGM1 than in UGM2. To alleviate this disparity the social capital creation system's social capital calculator (111) normalizes each UGM's (107) set of members (106) performance to the best likely performance possible taking geographical location data differences, in this example, but not limited to, into account. Thus, while all other social network identity data differences are zero across UGM1 and UGM2, except spatial distance, UMG's (107) resulting normalization to the most difficult case will result in a weighting factor for the resulting social capital score for UGM1 to be much lower than for UGM2. The calculated weighting factor is a multiplying coefficient applied to the highest possible social capital score that can be obtained by the UGM (107) set of members (106); the highest possible social capital score being based on, and proportional to, the number of members (106) in the UGM (107) set of members (106), complexity of the member's (106) organization into an organized list, and thus the length and number of interdependencies among each member (106) to each other member (106), task turn adjacent member-to-member social network identity data differences, and the difficulty in achieving the task in a set amount of time at the time scales predetermined by the software application's (108) task.

Further normalization calculations occur as well and are, but not limited to, the complexity of the organization of members (106) into the unique grouped member (107) set of members (106), the number of members (106) in the unique grouped member (107) set of members (106), the composition of member-to-member social network identity data differences, the number of dependencies a given member (106) must wait for before engaging in their task completion efforts, and the difficulty of the software application's (108) task.

What is claimed is:

1. A method of social capital creation in a social network comprising:
a plurality of social network members;
a social network identity data for each social network member;
a social capital creation system database;
a plurality of software task applications;
a social member organizing software application logic;
a social task organizing software application logic;
a social capital calculating software application logic; and
an application programming interface interfacing between the plurality of software applications and the social network's member, and grouped members, social network identity data to provide communication messaging methods, data passing methods, and data storage methods used to perform a social member organizing process, a social task organizing process, and a social capital calculating process to produce social capital measurement data based on the social network member's, and grouped member's, social network identity data, social member organization, and software application interactions used to complete a software application's task.

2. The method of claim 1 further comprising the social network identity data provided by the social networking member and saved into the social capital creation system database; wherein the identity data is comprised of the same classes and types of data as other social network members in the social network.

3. The method of claim 1 further comprising the social member organizing software application logic used to logically bind fellow social network members into groups of members and to save the grouped member's binding into the social capital creation system database.

4. The method of claim 1 further comprising the social member organizing software application logic used to sort grouped members into an ordered list and to save the ordered list into the social capital creation system database.

5. The method of claim 1 further comprising the social member organizing software application logic used to sort the member into an ordered list in a single member organized network topology and to save the ordered list into the social capital creation system database.

6. The method of claim 1 further comprising the social member organizing software application logic used to sort grouped members into an ordered list in a serially organized network topology and to save the ordered list into the social capital creation system database.

7. The method of claim 1 further comprising the social member organizing software application logic used to sort grouped members into an ordered list in a star organized network topology and to save the ordered list into the social capital creation system database.

8. The method of claim 1 further comprising the social member organizing software application logic used to sort grouped members into an ordered list in a tree organized network topology and to save the ordered list into the social capital creation system database.

9. The method of claim 1 further comprising the social member organizing software application logic used to sort grouped members into an ordered list in a mesh organized network topology and to save the ordered list into the social capital creation system database.

10. The method of claim 1 further comprising the social member organizing software application logic used to sort grouped members into an ordered list in a multi-network proxy organized network topology and to save the ordered list into the social capital creation system database.

11. The method of claim 1 further comprising the social capital calculating software application logic used to calculate social network identity data differences between each member's social network identity data based on the member's relative position to other members in an ordered list and to save the calculated social network identity data difference calculations into the social capital creation system database.

12. The method of claim 1 further comprising the social task organizing software application logic used to logically bind the software application's task to grouped members and to save the task and grouped members binding into the social capital creation system database.

13. The method of claim 1 further comprising the social capital calculating software application logic used to calculate a possible measurable performance the member can earn by completing the software application's task based on the member's relative position to other members in an ordered list and member's social network identity data differences and to save the possible measurable performance task completion calculations into the social capital creation system database.

14. The method of claim 1 further comprising the social capital calculating software application logic used to calculate a possible measurable performance the grouped members can earn by completing the software application's task based on each member's relative position to other members in an ordered list and each member's social network identity data differences and to save the possible measurable performance task completion calculations into the social capital creation system database.

15. The method of claim 1 further comprising the social capital calculating software application logic used to calculate the probability of the software application's task being completed between members based on the member's relative position to other members in an ordered list and member's social network identity data differences and to save the probability of task completion calculations into the social capital creation system database.

16. The method of claim 1 further comprising the social capital calculating software application logic used to calculate the probability of the software application's task completion by the grouped members based on the member's relative position to other members in an ordered list and member's social network identity data differences and to save the probability of task completion calculations into the social capital creation system database.

17. The method of claim 1 further comprising the social capital calculating software application logic used to calculate the member's measured performance in completing the software application's task and to save the member's measured performance calculations into the social capital creation system database.

18. The method of claim 1 further comprising the social capital calculating software application logic used to calculate the grouped member's measured performance in completing the software application's task and to save the grouped member's measured performance calculation into the social capital creation system database.

19. The method of claim 1 further comprising the social capital calculating software application logic used to calculate the member's social capital score based on the member's measured performance in completing the software application's task and to save the member's social capital score into the social capital creation system database.

20. The method of claim 1 further comprising the social capital calculating software application logic for a calculation of the grouped member's social capital score based on the grouped member's measured performance in completing the software application's task and to save the grouped member's social capital score into the social capital creation system database.

21. The method of claim 1 further comprising the application programming interface used by software applications to read and write to the member's, and grouped member's, social network identity data, social network identity data differences data, social member organization data, social task organization data, and social capital calculation data.

22. The method of claim 1 further comprising the application programming interface used by software applications to grant permission to members and grouped members to perform the software application's task.

23. The method of claim 1 further comprising the application programming interface used by software applications to monitor the state of the software application's task completion process and to save the state to the social capital creation system database.

24. A system for social capital creation in a social network comprising:
a plurality of social network members;
a social network identity data for each social network member;
a plurality of software task applications;
a social member organizer software application logic;
a social member organizer data;
a social task organizer software application logic;
a social task organizer data;
a social capital calculator software application logic;
a social capital calculator data;
a social capital creation system database; and
an application programming interface comprising of communication messaging methods, data passing methods, and data storage methods coupled to the plurality of software task applications and the social network's member, and grouped members, social network identity data, social member organizer data, social task organizer data, and social capital calculator data, wherein the application programming interface provides a set of communication messaging methods, data passing methods, and data storage methods to member computing and display devices and the social capital creation system database used to perform a social member organizing process, a social task organizing process, and a social capital calculating process used to produce social capital measurement data.

25. The system of claim 24 further comprising the member's computing and display device coupled to a graphical interface and the application programming interface, wherein the device's graphical user interface provides the means for the member, on their computing and display device, through a coupling of the application programming interface, to write to and read from social capital creation system database.

26. The system of claim 24 further comprising the social capital creation system database storing the member's social network identity data, grouped member's data, social organization data, social task organization data, and social capital calculator data, wherein the application programming interface is coupled to the software application providing a means to read and write to the social capital creation system database holding the data.

27. The system of claim 24 further comprising the social capital creation system database, wherein the social capital creation system database, and its data, is physically stored on the member's computing device and coupled to the application programming interface.

28. The system of claim 24 further comprising the social capital creation system database, wherein the social capital creation system database, and its data, is physically stored on a computing server, wherein the computing server is a centralized server and coupled to the application programming interface.

29. The system of claim 24 further comprising the social capital creation system database, wherein the social capital creation system database, and its data, is physically stored on computing servers, wherein the computing servers are physically distributed and logically coupled to the application programming interface.

30. The system of claim 24 further comprising the plurality of software applications coupled to the application programming interface and the member's computing and display device, wherein the plurality of software applications hold and present tasks to be completed by the member and grouped members.

31. The system of claim 24 further comprising the plurality of software applications, wherein the software applications are utility programs used by the member, and grouped members, to complete the software application's task of work, wherein the work task has a predetermined and measurable start and end state.

32. The system of claim 24 further comprising the plurality of software applications, wherein the software applications are game programs used by the member, and grouped members, to complete the software application's task of gaming, wherein the gaming task has a predetermined and measurable start and end state.

33. The system of claim 24 further comprising the plurality of software applications, wherein the software applications are social communication programs used by the member, and grouped members, to complete the software application's task of social communication, wherein the social communication task has a predetermined and measurable start and end state.

34. The system of claim 24 further comprising the plurality of software applications, wherein the software applications are content creation programs used by the member, and grouped members, to complete the software application's task of social content creation, wherein the social content creation task has a predetermined and measurable start and end state.
